(19) United States
(12) Patent Application Publication
(10) Pub. No.: US 2003/0032904 A1
(43) Pub. Date: Feb. 13, 2003

(54) Fitness device in the form of a garment

(76) Inventor: Norbert Egger, Salzburg (AT)

Correspondence Address: DARBY & DARBY P.C., Post Office Box 5257, New York, NY, 10150-5257, US

(21) Appl. No.: 10/198,066

(22) Filed: Jul. 17, 2002

Related U.S. Application Data
(63) Continuation of application No. PCT/EP00/13130, filed on Dec. 21, 2000.

(30) Foreign Application Priority Data
Jan. 18, 2000 (DE) 100 01 845.9

(51) Int. Cl. A61H 9/00

(52) U.S. Cl. 601/151

(57) ABSTRACT

The invention refers to a fitness device in the form of a garment for shaping the figure of a human body, said device comprising a sleeve which encloses the body at least partially in an airtight manner. A fitness device of this type is for instance known as a sweating suit. The sweating suit generates a sauna climate in its interior, which leads to an increased metabolism. Thus, the training results and the figure shaping may be improved. However, it is necessary for conventional sweating suits to wear these suits regularly over a longer period of time. Thus, the object of the invention is to provide a fitness device, which at least compared to the conventional sweating suits enables faster results in the figure shaping and which can be used in an aimed manner at certain parts of the body. According to the invention, this problem for a fitness device (1) of the above-mentioned kind is solved in that the sleeve forms a low pressure chamber (5) with at least one section of the body surface, said low pressure chamber being loaded with an air pressure that is lower compared to the atmosphere. The blood circulation is stimulated by the low pressure in the area of the low pressure chamber (5) and the metabolism in the fat-containing skin layers is increased. This leads to a faster reduction of fat. The fitness device may moreover be worn while simultaneously performing a regular workout training.

The present invention refers to a fitness device in the form of a garment for shaping the figure of a human body, said device comprising a sleeve which encloses the body at least partially in an airtight manner and which together with at least one section of the body surface forms at least one low pressure chamber which is loaded with an air pressure that is lower compared to the environment of the fitness device, the fitness device comprising at least one spacer through which the sleeve of the fitness device is kept at a distance to the body surface at least in the area of the low pressure chamber.

A fitness device of this type may for instance be a sweating suit enclosing the body in an airtight manner. The fitness effect of the sweating suit is based on the fact that the heat and moisture given off by the body cannot be discharged to the atmosphere through the air-tight sleeve. Thereby, temperature and air moisture rise in the interior of the suit and lead to a “sauna effect” within the suit. The metabolism of the body is thus increased by the sauna effect and the burning of fat is accelerated.

Sweating suits are usually designed in a way that they allow great freedom of movement, so that the person wearing the suit can for instance jog or cycle in it. The combination of physical exercise and sweating suit leads to an especially high circulatory efficiency and to an especially high metabolism. Thus, the exercise effect compared to the workout training without a sweating suit is increased.

The disadvantage of the conventional sweating suit is, however, that it basically increases the circulatory strain only but does not enable an aimed reduction of fat at the “problem zones”, e.g. at the abdomen, hips, buttocks or thighs. Moreover, the effect of the sweating suit is very restricted. In order to lastingly shape the body, the sweating suit must be used regularly over a long period of time.

In the most closely related coming prior art, U.S. Pat. No. 4,230,114, training pants are shown from which air is sucked off. The training pants are made of a non-porous and non-absorbing material. Flange-like spacers of a solid material are provided in the area of a suction hose, said spacers preventing that the fitness pants are sucked on in this area and shall thereby enable a regular distribution of the vacuum in the pants.

A fitness device in the form of a weight-lifter belt is known from U.S. Pat. No. 1,440,157, in which a spherical cap of an elastic material generates a vacuum in the abdominal portion.

A fitness suit is shown in U.S. Pat. No. 7,26,791, whose interior is loaded with a low pressure. Between the air-impervious sleeve and the body, an inner frame made of individual elements is provided in the interior of the suit.

In view of these disadvantages, the object of the present invention is to improve a fitness device of the above-mentioned kind in a manner that fat burning takes place faster and that problem zones can be treated in an aimed manner.

This problem is solved for a fitness device of the above-mentioned kind in that the spacer forms at least one overpressure chamber which is loaded with an air pressure that is higher compared to the environment of the fitness device.

The low pressure acting on the body surface in the area of the low pressure chamber leads to an increase of the blood circulation. This stimulation of the blood circulation leads to an increased fat burning in this area. If exercise is additionally made with the training device, e.g. if one jogs or cycles, the sauna effect and the vacuum effect superimpose in the area of the low pressure chamber. This combination of workout training and low pressure leads to an especially aimed reduction of fat at the location of the low pressure chamber.

The blood circulation is stimulated to a greater extent by the low pressure than is the case in conventional sweating suits. The efficiency of the training device for shaping the figure and fat burning according to the invention is therefore significantly higher than in conventional sweating suits.

There is a risk in the area of the low pressure chamber that the sleeve engages the body surface due to the low pressure. This would lead to a reduction in wearing comfort or to a reduction of the effect of the low pressure. To avoid this, the fitness device comprises at least one spacer through which the sleeve of the fitness device is kept at a distance from the body surface at least in the area of the low pressure chamber.

The spacer forms at least one overpressure chamber which is loaded with a pressure that is higher compared to the atmosphere of the fitness device. The overpressure chamber enables a high wearing comfort, since in this embodiment the spacer may adapt to the body contour.

In an especially advantageous embodiment, the section loaded with low pressure may comprise the abdomen and/or the buttocks and/or the hips and/or the thighs. These body parts represent the conventional problem zones on which fat can easily deposit caused by genetic preconditions or due to a lack of exercise.

In order to avoid a separate supply of the overpressure chamber and the low pressure chamber and to thereby avoid an increased constructive effort for supplying pressure, the overpressure chamber may be enclosed by an at least section-wise airtight spacer sleeve through which the air can be discharged under loss of pressure from the overpressure chamber into the low pressure chamber and/or the atmosphere. Additionally, or as an alternative, the overpressure chamber may be formed with a throttle valve, through which air can be output under loss of pressure from the overpressure chamber into the low pressure chamber and/or the atmosphere. In these two embodiments it is possible to supply the air first of all under pressure to the overpressure chamber, from which it is conducted, under loss of pressure, into the low pressure chamber. The air is then sucked out of the low pressure chamber. The loss of pressure through the air-pervious spacer sleeve and/or the throttle valve is required to maintain the pressure difference between the overpressure chamber and the low pressure chamber. The advantage of this embodiment is to be seen in that a specially designed discharge of air from the overpressure chamber and a specially designed supply of air into the overpressure chamber may not be necessary be renounced, since the discharge air from the overpressure chamber supplies the low pressure chamber.

In a further advantageous embodiment, the spacer may also at least section-wise be made of a solid material. A solid material in this connection is a material which is able to keep the sleeve away from the body surface due to its inherent strength. In order to ensure an appropriate freedom of movement when the fitness device is used for physical exercise, the solid material can also have resilient properties. The resiliency may originate from a corresponding design or choice of material.

In a further advantageous embodiment, the fitness device may be provided with a pump means having an overpressure output, wherein the overpressure output of the pump means is connected to the overpressure chamber. Here, the pump means serves for generating the overpressure arranged in the overpressure chamber of the spacer.

It is also possible that at the same time the pump output is connected to the overpressure chamber and the pump input is connected to the low pressure chamber. The overpressure chamber may be connected to the low pressure chamber so that a closed or almost closed air circulation is generated.

In order to avoid damage to the fitness device and to prevent physiologically harmful low pressures, the low pressure chamber in a further advantageous embodiment may be equipped with a low pressure safety valve through which air can be introduced into the low pressure chamber when the pressure drops below a predetermined minimum pressure. In this embodiment, the low pressure safety valve opens automatically if the pressure falls below a value that is harmful to the body or for the training device.

Accordingly, the overpressure chamber may be equipped with an overpressure safety valve through which air can be discharged from the overpressure chamber when a predetermined maximum pressure is exceeded. The overpressure safety valve prevents bursting of the overpressure chamber in case of a too high pressure build-up or a cutting-off of the body caused by heavy inflation of the overpressure chamber or of the spacer, in that it opens automatically when exceeding the maximum pressure.

Advantageously, the fitness device may also comprise sealing sections which sealingly engage the body surface and which basically completely enclose the low pressure chamber. These sealing sections prevent leakage and air flow into the low pressure chamber. Thereby, the pump energy is utilized more efficiently and the service liefe of pumps, which for instance use batteries or accumulators as energy source, is significantly prolonged.

The fitness device may be formed in a bandage-like manner for the aimed shaping of body sections. In this embodiment, the fitness device may for instance be put around one thigh, respectively, to achieve the shaping of the thigh in an aimed manner. As an alternative, the fitness device may also be designed in a manner that it is only put around the hips which leads to an increase in blood circulation in the hip, abdomen and buttocks area. The fitness devices are very compact in this embodiment and may be especially adapted to the needs of their users.

As an alternative, the fitness device may also be formed in a suit-like manner, wherein it acts as a sweating suit in the areas in which low pressure chambers are not formed, as has been described above.

In order to avoid a failure of the entire fitness device in the case of a damage of the low pressure chamber, and to adapt the low pressure independently to different body portions, the fitness device of a further embodiment may comprise a plurality of low pressure chambers, which are assigned to individual body portions. In this embodiment it is possible to load e.g. the thigh with a low pressure different from the low pressure applied to the buttocks. This may for instance be advantageous in the case of different skin sensitivities at different body portions.

In a further advantageous embodiment, a pressure control means may be provided through which the low pressure in the low pressure chamber can be regulated to a certain value. This value can for instance be adjusted by the user him/herself. An adjustability of the low pressure may for instance become necessary when the fitness device is once operated on sea level and another time in a mountain resort. The different air pressure at both locations requires a differently great low pressure in the low pressure chamber.

Now the structure and the function of the fitness device according to the invention will be explained with reference to the drawings by means of embodiments.

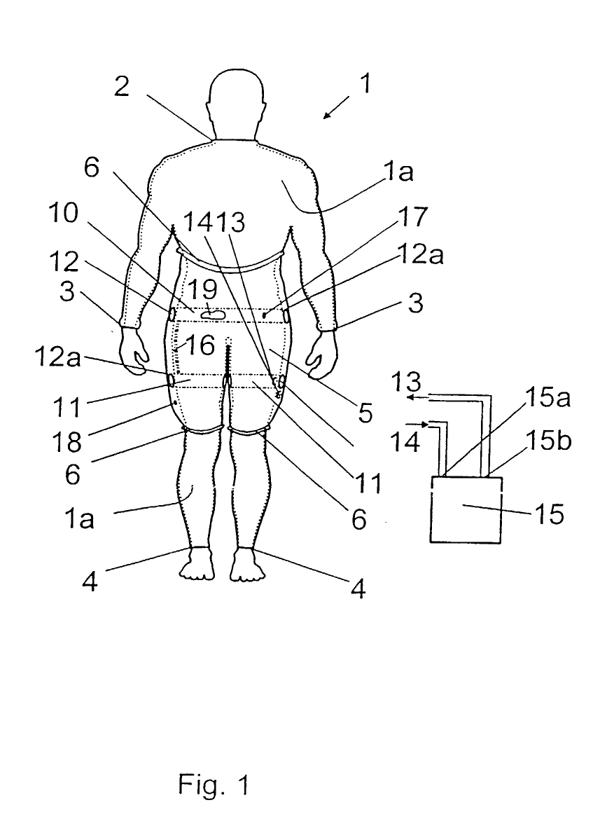

FIG. 1 shows a first embodiment of the fitness device according to the invention;

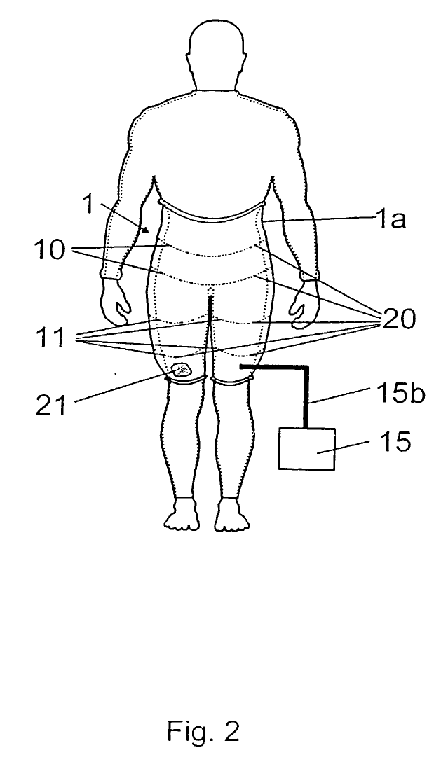

FIG. 2 shows a second embodiment of the fitness device according to the invention;

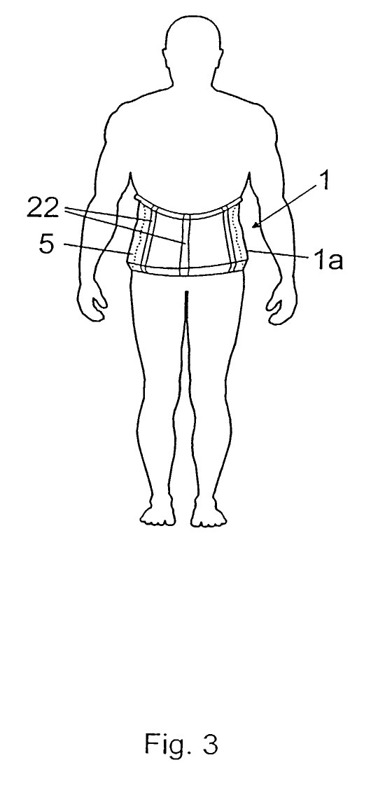

FIG. 3 shows a third embodiment of the fitness device according to the invention;

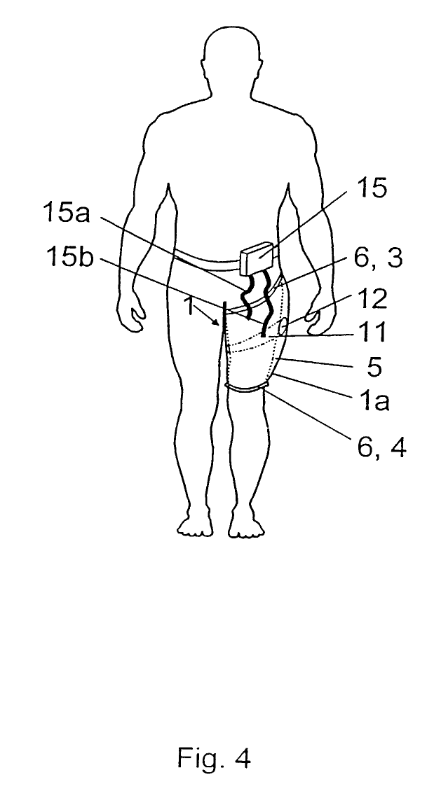

FIG. 4 shows a fourth embodiment of the fitness device according to the invention.

FIG. 1 shows a fitness device 1, which is designed in the form of a suit enclosing the entire body, the arms and the legs, similar to a divers' suit. The suit is made of an air-impervious sleeve 11a and is provided with seals 2, 3, 4 at the ends of the collar, at the sleeves and on the ankles.

On the inner surface facing the body, the fitness device is provided with a layer (not shown) kind to the skin, which ensures high wearing comfort to the user also in case he/she is sweating.

In the embodiment of FIG. 1, the fitness device is provided with one single low pressure chamber 5 which extends over the buttocks, the hips, the abdomen and the thighs. As an alternative, separate low pressure chambers 5 may also be provided for these portions, respectively.

The low pressure chamber 5 is enclosed by seals 6, which prevent the inflow of pressurized ambient air into the pressure chamber 5.

The sleeve 1a of the fitness device is held in a manner spaced apart from the body surface by spacers 10, 11 in the area of the low pressure chamber 5. The spacer 10 in the hip area is designed in a belt-like manner and is provided with an overpressure chamber 12 whose interior is loaded with a pressure which is higher than the ambient pressure of the fitness device 1. Due to the pressure difference, the sleeve 12a of the overpressure chamber 12 is inflated.

Two further spacers 11 are formed above the knee. The spacers 11 are also provided with an overpressure chamber 12.

The overpressure chamber 12 is provided with a terminal 13 to which an overpressure hose from the output side of a pump may be connected. The low pressure chamber 5 is provided with a vacuum terminal 14 to which the suction or input side of a pump 15 can be connected.

In the embodiment of FIG. 1, the overpressure terminal 13 and the low pressure terminal 14 are both connected to the pump 15. The suction side 15a of the pump 15 generates the low pressure in the low pressure chamber 5, and the supply side 15b of the pump 15 pumps air into the overpressure chamber 12 of the spacer 12.

As an alternative, the low pressure chamber 5 and the overpressure chamber 12 may also each be operated by a separate pump. The low pressure chamber 12 of the spacer 10 at the hip is connected to the overpressure chamber 12 of the spacers 11 at the legs via a connection line 16 and is supplied with air via this line.

Each overpressure chamber 12 is provided with a pressure control valve 17, which opens if a predetermined maximum pressure is exceeded within the overpressure chamber, and which therefore avoids bursting of the overpressure chamber. The low pressure chamber 5 is also provided with a vacuum safety valve, which opens automatically when the pressure drops below a certain value so that air may then flow into the low pressure chamber 5. In this manner, health defects caused by too high low pressure in the low pressure chamber 5 and a damage of the fitness device are prevented.

The overpressure chamber 12 may also be provided with a discharge portion 19, through which air flows from the overpressure chamber 12 into the low pressure chamber 5. The discharge portion 19 has a significant flow resistance so that a pressure head builds up between the overpressure chamber 12 and the low pressure chamber 5. The size of the discharge portion 19 is dimensioned such that less air, at least as much air flows through the flow-out portion 19 of the overpressure chamber 12 into the low pressure chamber 5 as can be sucked out due to the capacity of the pump 15. Only if this dimensioning rule is followed is it possible to build up and maintain a vacuum in the low pressure chamber 5 relative permanently to the overpressure in the overpressure chamber 12. As an alternative, the air can also be discharged to the atmosphere via the discharge portion 19.

FIG. 2 describes a second embodiment of the present invention. Instead of a spacer 10 inflatable by overpressure, a cage-like spacer 20 made of a solid plastic material is used in the embodiment of FIG. 2. The cage-like structure leads to a regular spacing of the sleeve 1a of the fitness device 1 from the body without a high pressure being exerted on individual body portions, since the cage contacts the body on a large surface.

In the embodiment of FIG. 2, the fitness device moreover comprises a partially air-pervious flow-in portion 21 through which the air sucked off by the pump can flow in.

Instead of the cage of FIG. 2 between the body and the sleeve 1a, spacers integrated into the sleeve may also be used, which form a carrier frame for the low pressure chamber 5 for instance in the shape of bent laths. The laths 22 keep the sleeve 1a away from the body surface and at the same time ensure a high movability of the person wearing it. A carrier frame in the sleeve of this kind is shown in FIG. 3, which shows a third embodiment of the fitness device 1 according to the invention.

The fitness device of FIG. 3 is not designed as a suit but is put in a belt-like or bandage-like manner around the abdomen, the hips and the buttocks. The fitness device 1 of FIG. 3 basically comprises one low pressure chamber only, which is sealed on the bottom and on the top by seals 6. The low pressure chamber in this example has a fully airtight sleeve through which air cannot flow into the low pressure chamber. For simplicity's sake, the pump and the low pressure lines are left out in FIG. 3.

FIG. 4 shows a fourth embodiment of the fitness device according to the invention which is formed as a bandage for a thigh. In this form, the fitness device is particularly suitable for the reduction of fat on the thigh, e.g. in the case of so-called jodhpur thighs. Depending on the size, the fitness device of this embodiment can also be put around the (upper) arms to contribute to the reduction of fat there.

The pump means 15 with the lines 15a, 15b is designed in FIG. 4 as being portable on the body. Energy sources, such as accumulators or batteries are integrated in this pump means.

The embodiments of FIGS. 3 and 4 give the person wearing the device a great freedom of movement and can thus especially be used for normal exercise work for supporting the exercise effect.

The function of the fitness device according to the invention will now be explained.

The principle of the fitness device for forming the figure is based on the fact of increasing the local blood circulation by applying a low pressure. The increased blood circulation leads to an increased metabolism and thus to a locally increased fat burning. The increase in fat burning leads to an aimed fat reduction at the portions treated with low pressure.

To switch on the fitness device 1 the pump 15 is operated. The low pressure input 15a of the pump sucks air from the low pressure chamber 5 and thereby generates the low pressure in the low pressure chamber.

If a spacer is provided with an overpressure chamber 12, this spacer is connected to the overpressure output 15b of the pump and it is pumped up so that a contact of the sleeve 1a of the fitness device 1 with the body surface is prevented. The overpressure chamber 12 may also be supplied by an independent pump so that the low pressure chamber 5 and the overpressure chamber 12 are supplied by individual pumps each.

In order to enable jogging or cycling with the fitness device, the pump 15 is designed in a manner that it can be worn on the body of the person carrying the fitness device. For this purpose it is equipped with an internal energy supply (not shown). The pump 15 is furthermore provided with a control means which regulates the pressure in the low pressure chamber 5 and/or the overpressure chamber 12 to a predetermined value that can be regulated by hand.

1. A fitness device (1) in the form of a garment, for shaping the figure of a human body, comprising a sleeve (1a) which at least partially encloses the body in an airtight manner and which together with at least one section of the body surface forms at least one low pressure chamber (5) which is loaded with an air pressure that is lower compared to the atmosphere of the fitness device (1), wherein the fitness device (1) comprises at least one spacer (10, 11) through which the sleeve (1a) of the fitness device (1) is spaced apart from the body surface at least in the area of the low pressure chamber (5), characterized in that the spacer (10) forms at least one overpressure chamber (12) which is loaded with a pressure that is higher compared to the environment of the fitness device (1).

2. A fitness device as claimed in claim 1, characterized in that the section loaded with low pressure comprises abdomen and/or buttocks and/or hips and/or thighs.

3. A fitness device as claimed in claim 1 or 2, characterized in that the overpressure chamber (12) is enclosed by a spacer sleeve (12a) that is air-pervious at least section-wise, through which said spacer sleeve air, under loss of pressure, can be discharged from the overpressure chamber (12) into the low pressure chamber (5) and/or the atmosphere.

4. A fitness device as claimed in one of the above-mentioned claims, characterized in that the overpressure chamber (12) is formed with a throttle valve, through which, under loss of pressure, air can be discharged from the overpressure chamber (12) into the low pressure chamber (5) and/or the atmosphere.

5. A fitness device as claimed in one of the above-mentioned claims, characterized in that the spacer (10, 11) is made at least section-wised of a solid material.

6. A fitness device as claimed in one of the above-mentioned claims, characterized in that the spacer (10, 11) is arranged between the sleeve (1a) of the low pressure chamber and the body surface

7. A fitness device as claimed in one of the above-mentioned claims, characterized in that the spacer (10, 11) is formed at least section-wise in a belt-like manner.

8. A fitness device as claimed in one of the above-mentioned claims, characterized in that the spacer (10, 11) is formed at least section-wise in a cage-like manner.

9. A fitness device as claimed in one of the above-mentioned claims, characterized in that the fitness device (1) is provided with a pump device (15) with a low pressure input, wherein the low pressure input is connected to the low pressure chamber (5)

10. A fitness device as claimed in one of the preceding claims, characterized in that the fitness device (1) is provided with a pump device (15) with an overpressure output, wherein the overpressure output (15b) is connected to the overpressure chamber (12).

11. A fitness device as claimed in one of the preceding claims, characterized in that the pump means (15) is designed in a manner that it can be worn on the body of the person wearing the fitness device (1).

12. A fitness device as claimed in one of the preceding claims, characterized in that the overpressure chamber (12) is equipped with an overpressure safety valve (17) through which air can be discharged from the overpressure chamber (12) when a predetermined maximum pressure is exceeded.

13. A fitness device as claimed in one of the preceding claims, characterized in that the low pressure chamber (5) is equipped with a vacuum safety valve (18) through which air can be introduced into the low pressure (5) when the pressure drops below a predetermined minimum value.

14. A fitness device as claimed in one of the preceding claims, characterized in that the fitness device (1) comprises sealing portions (6) which sealingly engage the body surface and which basically fully enclose the low pressure chamber (5).

15. A fitness device as claimed in one of the preceding claims, characterized in that the fitness device (1) is shaped in a substantially bandage-like manner for the aimed shaping of individual body parts.

16. A fitness device as claimed in one of the preceding claims, characterized in that the fitness device (1) is substantially formed suit-like.

17. A fitness device as claimed in one of the preceding claims, characterized in that the fitness device (1) comprises a plurality of low pressure chambers (5) which are associated to individual body sections.

18. A fitness device as claimed in one of the preceding claims, characterized in that a pressure regulating means is provided through which the low pressure in the low pressure chamber (5) can be regulated to a predetermined value.
